(19) United States
(12) Patent Application Publication
(10) Pub. No.: US 2024/0424638 A1
(43) Pub. Date: Dec. 26, 2024

(54) SYSTEM AND METHOD FOR AUTONOMOUS SANDING

(71) Applicant: Outer Woods LLC, Austin, TX (US)

(72) Inventor: Tanner Rowley, Austin, TX (US)

(21) Appl. No.: 18/752,391

(22) Filed: Jun. 24, 2024

Related U.S. Application Data
(60) Provisional application No. 63/522,799, filed on Jun. 23, 2023.

(51) Int. Cl. B24B 51/00; B24B 23/00; B24B 47/20; B24B 49/02

(52) U.S. Cl. CPC B24B 51/00; B24B 23/005; B24B 47/20; B24B 49/02

(57) ABSTRACT

Methods and systems are described herein for surface treatment operations using an autonomous sander system (“system”). The system may include a drive system operatively coupled to a chassis, so that the drive system is able to propel the autonomous sander system across a workpiece. The system may include a processor coupled to the autonomous sander system and area-monitoring sensors so that the processor may direct the system to perform a sanding operation based on information gathered from the surrounding environment by the sensors. The system performs the sanding operation by obtaining a surface treatment command that includes a threshold condition; obtaining workpiece assessment data from the sensors based on the command; directing the system to execute the sanding operation; directing the drive system to propel the sander along a desired path; and terminating the operation if a threshold condition is met.

### CROSS-REFERENCE TO RELATED APPLICATIONS

This application claims benefit of U.S. Provisional Patent Application 63/522,799, titled “A Self-Driving Robot That Autonomously Sands and Smooths a Flat Workpiece,” filed 23 Jun. 2023. The entire content of each aforementioned patent filing is hereby incorporated by reference.

### BACKGROUND

### 1. Field

The present disclosure generally relates to power tools, and more specifically, the present disclosure relates to systems and methods for autonomous sanding with an autonomous sander, according to various embodiments.

### 2. Description of the Related Art

Woodworking is an art that demands precision, smooth finishes, and efficiency in material removal. Sanders are often used to finish and smooth woodworking pieces. However, these systems often fall short in several critical areas, impeding their effectiveness and usability. Most woodworking projects require a skilled worker to physically operate a manual handheld finishing sander to perform the final material removal. This final round of material removal prepares the surface for completion. Handheld finishing sanders require an operator to remain engaged for multiple hours at a time, preventing that operator from accomplishing other tasks.

An alternative to hand sanding is to use stationary drum sanders and wide belt sanders that remove material quickly and without excessive labor and energy devoted by the operator(s). However, these sanding devices often leave streaks, marks, and artifacts on the surface of the workpiece. The streaks, marks, and artifacts left by stationary drum sanders and wide belt sanders need to be removed by handheld finishing sanders. Thereby reducing the time-saving benefits of using a stationary sander. Further, stationary drum sanders and wide belt sanders are very large and take up a large footprint on the shop floor.

By virtue of their construction, stationary drum sanders and wide belt sanders require the workpiece to be fed through the machine. Accordingly, the workpiece must be maneuvered and lifted. Because workpieces can be large and heavy, it is often impractical to operate stationary drum sanders or wide belt sanders in a shop with limited manpower.

Another significant issue is the ergonomic deficiencies of existing sanders. Prolonged use can lead to user fatigue, discomfort, and even repetitive strain injuries due to poor design. Many sanders lack adjustable handles or grips that accommodate different hand sizes and working positions, causing strain on the user's hands, wrists, and arms. This not only reduces overall efficiency but also increases the risk of injury, particularly during extended use.

Excessive vibration and noise are also problems in many sanders. High levels of vibration can cause user fatigue and negatively impact the precision of the sanding process, while noise pollution can contribute to hearing loss over time and create an unpleasant working environment. Additionally, achieving a uniformly smooth surface is often a challenge with sanders, which can easily produce uneven results. Poor pad design, inconsistent pressure distribution, and inadequate motor control can leave behind swirl marks, gouges, or other surface imperfections, necessitating additional finishing steps and increasing the time and effort required to complete a project.

One of the primary concerns with current sanders is their inadequate dust collection systems. Woodworking generates a substantial amount of fine dust, which can be harmful to both the user's health and the working environment. Many current models fail to capture all the dust, leading to a messy workspace and potential respiratory issues for the user.

Moreover, the power and speed control limitations of current sanders restrict their versatility. Many models offer limited or imprecise control over these parameters, which is crucial for different sanding tasks and materials. This can result in suboptimal performance, with users either removing too much material or not enough, depending on the specific requirements of the task. These combined issues highlight the need for innovation in sander design to improve dust collection, ergonomics, vibration and noise control, sanding consistency, and power and speed control, ultimately enhancing the functionality and user experience of sanders in woodworking.

### SUMMARY

The following is a non-exhaustive listing of some aspects of the present techniques. These and other aspects are described in the following disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a non-transitory, machine-readable medium storing instructions that, when executed by at least one processor, effectuate operations that may include obtaining, via the processor, a surface treatment command for an autonomous sander system, where the surface treatment command includes a threshold condition. The medium may also include obtaining, via the processor, workpiece assessment data from at least one area-monitoring sensor based on the surface treatment command. The medium may furthermore include directing, via the processor, the autonomous sander system to execute a sanding operation on the workpiece based on the surface treatment command and the workpiece assessment data. The medium may in addition include directing, via the processor, a drive system to propel the autonomous sander system across the workpiece in accordance with the sanding operation. The medium may moreover include terminating, via the processor, the sanding operation if the autonomous sander system satisfies the threshold condition. Other embodiments of this aspect include corresponding computer systems, apparatus, and computer programs recorded on one or more computer storage devices, each configured to perform the actions of the methods.

Implementations may include one or more of the following features. The medium where the threshold condition is a time period, and where the processor terminates the sanding operation when the time period expires. The medium where the threshold condition is a sanding indicia score, and where the processor terminates the sanding operation when the workpiece assessment data includes the sanding indicia score that indicates the workpiece is free of sanding indicia. The medium where the sanding operation may include: directing, via the processor, the drive system to propel the autonomous sander system in a first direction; directing, via the processor, a sanding component of the autonomous sanding system to sand a surface of the workpiece; directing, via the processor, the drive system to stop the autonomous sander system if the workpiece assessment data indicates an edge or obstacle is within a threshold distance of the autonomous sander system in the first direction; integrating, via the processor, the workpiece assessment data into an area map of the workpiece; determining, via the processor, if the area map is sufficiently detailed to model the workpiece surface; and executing, via the processor, a path refinement operation based on the determining. The medium where the path refinement operation includes directing, via the processor, the drive system to maneuver the autonomous sander system to be propelled along a second direction if the area map is not sufficiently detailed. The medium where the path refinement operation further may include: generating, via the processor, an optimal path for the autonomous sander system to travel during the sanding operation; and directing, via the processor, the drive system to maneuver the autonomous sander system to be propelled along the optimal path during the sanding operation. The medium where the sanding operation further may include restarting the optimal path if the threshold condition is not satisfied. The medium where the autonomous sanding system further may include a sanding device detachably coupled to a chassis. Implementations of the described techniques may include hardware, a method or process, or a computer tangible medium.

In one general aspect, an autonomous sander system may include a chassis. The autonomous sander system may also include a drive system operatively coupled to the chassis, where the drive system is configured to propel the autonomous sander system across a workpiece. The autonomous sander system may furthermore include at least one processor coupled to the autonomous sander system and at least one area-monitoring sensor. The autonomous sander system may in addition include system memory coupled to the at least one processor and that includes at least one instruction that, when executed by the at least one processor, effectuate operations. The autonomous sander system may moreover include obtaining a surface treatment command for the autonomous sander system, where the surface treatment command includes a threshold condition. The autonomous sander system may also include obtaining workpiece assessment data from the at least one area-monitoring sensor based on the surface treatment command. The autonomous sander system may furthermore include directing the autonomous sander system to execute a sanding operation on the workpiece based on the surface treatment command and the workpiece assessment data. The autonomous sander system may in addition include directing the drive system to propel the autonomous sander system across the workpiece in accordance with the sanding operation. The autonomous sander system may moreover include terminating the sanding operation if the autonomous sander system satisfies the threshold condition. Other embodiments of this aspect include corresponding computer systems, apparatus, and computer programs recorded on one or more computer storage devices, each configured to perform the actions of the methods.

Implementations may include one or more of the following features. The system where the threshold condition is a time period, and where the processor terminates the sanding operation when the time period expires. The system where the threshold condition is a sanding indicia score, and where the processor terminates the sanding operation when the workpiece assessment data includes the sanding indicia score that indicates the workpiece is free of sanding indicia. The system where the sanding operation may include: directing, via the processor, the drive system to propel the autonomous sander system in a first direction; directing, via the processor, a sanding component of the autonomous sanding system to sand a surface of the workpiece; directing, via the processor, the drive system to stop the autonomous sander system if the workpiece assessment data indicates an edge or obstacle is within a threshold distance of the autonomous sander system in the first direction; integrating, via the processor, the workpiece assessment data into an area map of the workpiece; determining, via the processor, if the area map is sufficiently detailed to model the workpiece surface; and executing, via the processor, a path refinement operation based on the determining. The system where the path refinement operation includes directing, via the processor, the drive system to maneuver the autonomous sander system to be propelled along a second direction if the area map is not sufficiently detailed. The system where the path refinement operation further may include: generating, via the processor, an optimal path for the autonomous sander system to travel during the sanding operation; and directing, via the processor, the drive system to maneuver the autonomous sander system to be propelled along the optimal path during the sanding operation. The system where the sanding operation further may include restarting the optimal path if the threshold condition is not satisfied. The system where the autonomous sanding system further may include a sanding device detachably coupled to a chassis. Implementations of the described techniques may include hardware, a method or process, or a computer tangible medium.

In one general aspect, a method may include obtaining, via at least one processor, a surface treatment command for an autonomous sander system, where the surface treatment command includes a threshold condition. The method may also include obtaining, via the processor, workpiece assessment data from at least one area-monitoring sensor based on the surface treatment command. The method may furthermore include directing, via the processor, the autonomous sander system to execute a sanding operation on the workpiece based on the surface treatment command and the workpiece assessment data. The method may in addition include directing, via the processor, a drive system to propel the autonomous sander system across the workpiece in accordance with the sanding operation. The method may moreover include terminating, via the processor, the sanding operation if the autonomous sander system satisfies the threshold condition. The method may furthermore include directing, via the processor, the drive system to propel the autonomous sander system in a first direction. The method may in addition include directing, via the processor, a sanding component of the autonomous sanding system to sand a surface of the workpiece. The method may moreover include directing, via the processor, the drive system to stop the autonomous sander system if the workpiece assessment data indicates an edge or obstacle is within a threshold distance of the autonomous sander system in the first direction. The method may also include integrating, via the processor, the workpiece assessment data into an area map of the workpiece. The method may furthermore include determining, via the processor, if the area map is sufficiently detailed to model the workpiece surface. The method may in addition include executing, via the processor, a path refinement operation based on the determining. The method may moreover include where the path refinement operation includes directing, via the processor, the drive system to maneuver the autonomous sander system to be propelled along a second direction if the area map is not sufficiently detailed. The method may also include where the path refinement operation further may include. The method may furthermore include generating, via the processor, an optimal path for the autonomous sander system to travel during the sanding operation. The method may in addition include directing, via the processor, the drive system to maneuver the autonomous sander system to be propelled along the optimal path during the sanding operation. The method may moreover include directing, via the processor, the autonomous sander system to restart the optimal path if the threshold condition is not satisfied. Other embodiments of this aspect include corresponding computer systems, apparatus, and computer programs recorded on one or more computer storage devices, each configured to perform the actions of the methods.

Implementations may include one or more of the following features. The method where the threshold condition is a time period, and where the processor terminates the sanding operation when the time period expires. The method where the threshold condition is a sanding indicia score, and where the processor terminates the sanding operation when the workpiece assessment data includes the sanding indicia score that indicates the workpiece is free of sanding indicia. The method where the autonomous sanding system further may include a sanding device detachably coupled to a chassis. Implementations of the described techniques may include hardware, a method or process, or a computer tangible medium.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1A shows a perspective view of an autonomous sanding system, consistent with various embodiments.

FIG. 1B shows a front view of the autonomous sanding system, consistent with various embodiments.

FIG. 1C shows a front view of the autonomous sanding system with a detachable sanding device, consistent with various embodiments.

FIG. 1D shows a top view of the autonomous sanding system, consistent with various embodiments.

FIG. 1E is a block diagram of connections between components of the autonomous sanding system, consistent with various embodiments.

FIG. 2 shows a flowchart of a method for autonomous workpiece sanding, consistent with various embodiments.

FIG. 3 is a block diagram of the nested control loop structure for a sanding operation, consistent with various embodiments.

FIG. 4 shows an example of a computing device by which the present techniques may be implemented, in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the field of power tools and sanders. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

In some embodiments, the disclosed concept relates to an autonomous sanding system that may utilize a sensor array to monitor a workpiece's surface while performing sanding operations (e.g., removing portions of material from the surface of the workpiece, buffing, burnishing, detecting and avoiding obstacles or edges, generating a map or model of the workpiece or the surrounding area, plotting optimal paths to sand the surface to a desired finish or smoothness). In some embodiments, optimal paths may include routines that enable the autonomous sanding system to perform the sanding operation most efficiently. For example, the optimal path may include a route that addresses rougher sections of the surface when using fresh sandpaper to maximize material removal. In some embodiments, the autonomous sanding system may perform sanding operations by traveling over a planar surface of the workpiece (e.g., the surface of a tabletop or cabinet). In various embodiments, the autonomous sanding system may perform sanding operations by traveling over a contoured surface of the workpiece. The autonomous sanding system may be further configured to operate with or without user supervision and complete sanding operations based on predefined routines or optimal paths that are dynamically generated from real-time identification of relevant workpiece features (e.g., curves, edges, elevation changes, obstacles, fasteners, hardware, glass components, wet paints/stains/epoxies).

In some embodiments, the autonomous sanding system may feature a chassis with a detachable sanding device. The chassis may act as a universal sander receiver capable of performing sanding operations with a variety of different sanding devices and third-party systems. Further, the chassis may contain the necessary sensor systems, power systems, and data processing systems to perform sanding operations with any portable sanding device. Further, the detachable sanding device may be repaired or replaced without affecting the chassis. In some embodiments, the sanding device may be integrated into the chassis and not detachable. The integrated sanding device may enable the autonomous sanding system to operate in tight spaces and reduce the system's overall size and weight.

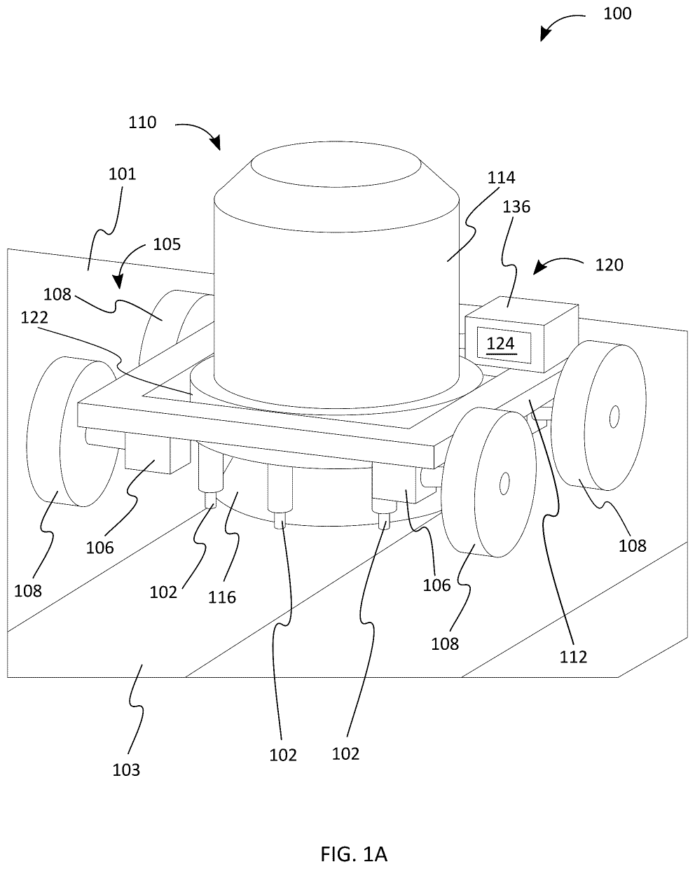

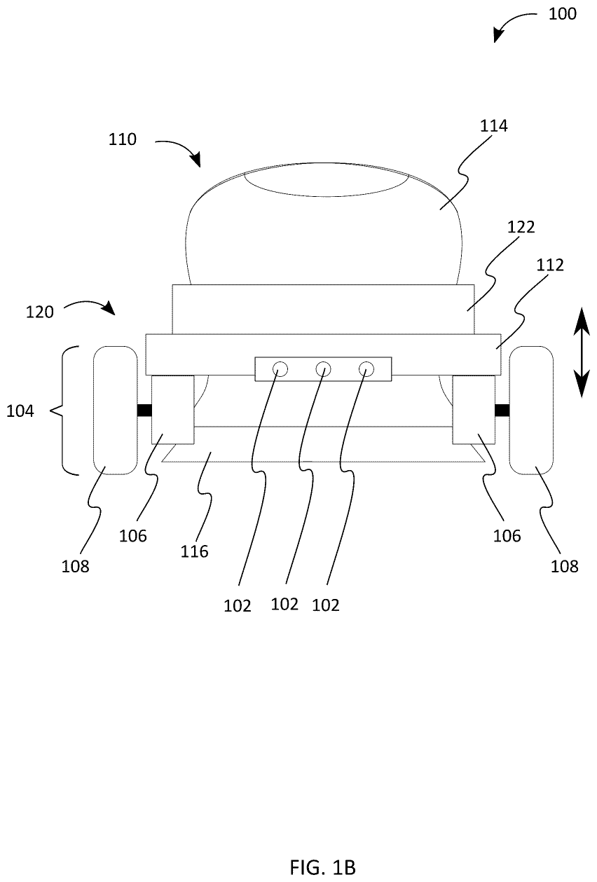

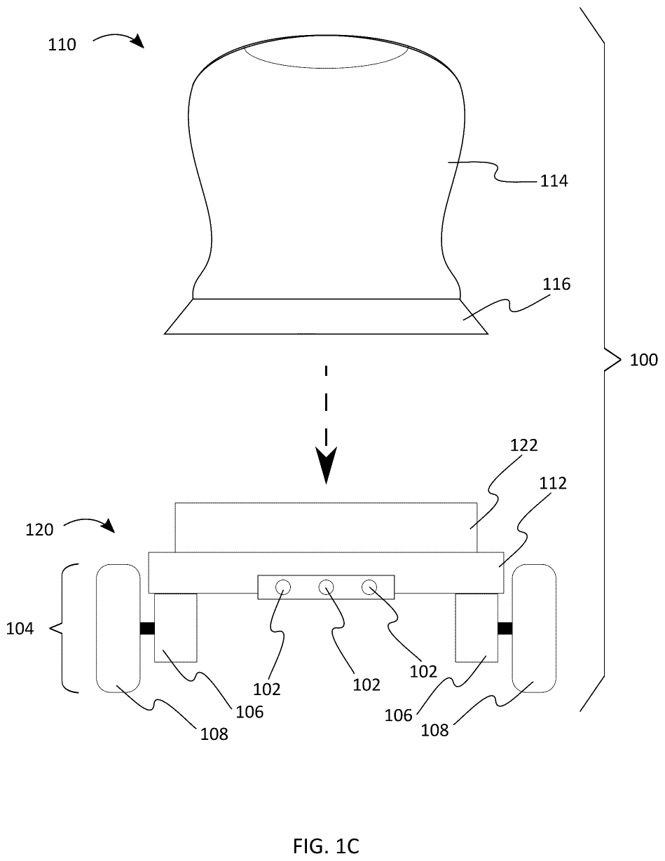

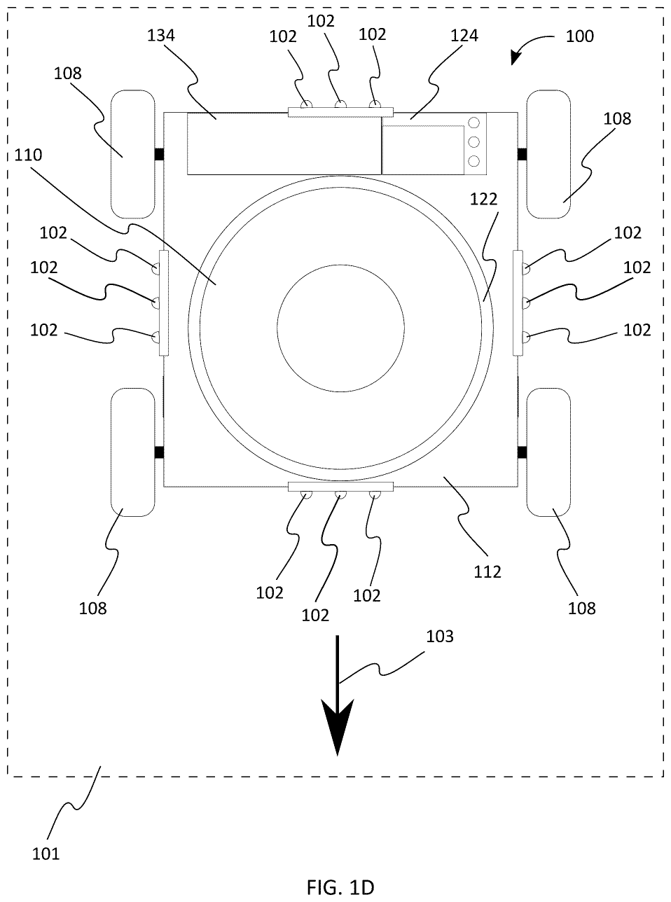

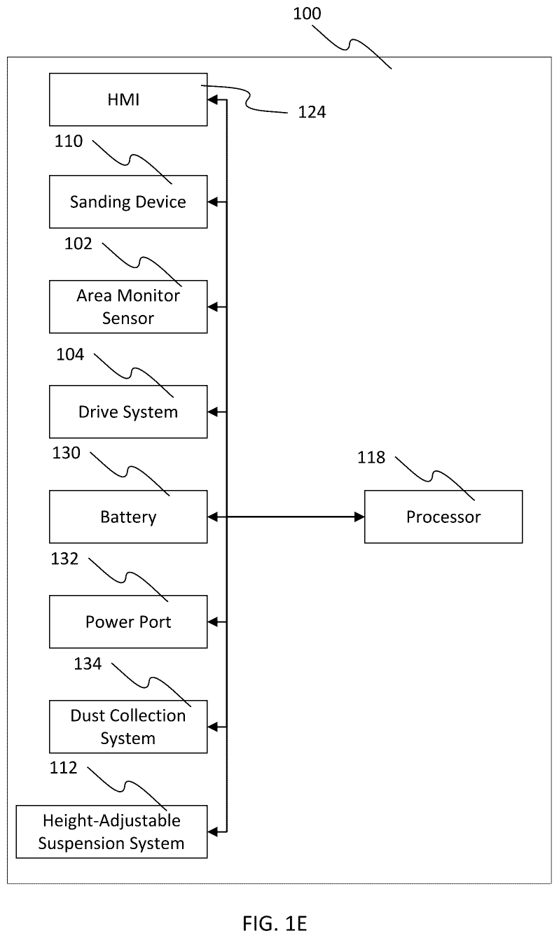

Referring now to FIGS. 1A, 1B, 1C, 1D, and 1E, an embodiment of an autonomous sanding system 100 is illustrated. FIG. 1A shows an embodiment of the autonomous sanding system 100 generating a traveling path 103 across a surface 105 of a workpiece 101. In some embodiments, the system 100 is designed to automatically determine and execute the sanding operations required to smooth the surface 105 to a desired finish. To achieve this functionality, the system 100 may comprise at least one area monitor sensor 102, a sanding device 110, and a chassis 120. The at least one area monitor sensor 102 may include sensors (e.g., LIDAR, three-dimensional (3D) sonar, computer vision, thermal imaging, magnetometers, gyroscopes, accelerometers, rotary encoders, linear encoders, optical encoders, and chemical sensors) designed to monitor the state of the surface 105 and identify the system's 100 position relative to obstacles and edges of the workpiece 101. In some embodiments, the chassis 120, may be a height-adjustable carriage that enables the sanding device 110 (e.g., a belt sander, a random orbital sander, a disc sander, a finishing sander) to be maneuvered across the workpiece 101 along a path 103. Further, the height-adjustable feature of the chassis 120 enables a sanding element 116 of the sanding device 110 to be positioned into contact with, or retracted away from, the surface 105, in accordance with the sanding operation. For example, when the sanding operation calls for the system 100 to begin sanding, the chassis 120 may position the sanding element 116 into contact with the surface 105. In some embodiments, a plurality of area-monitoring sensors 102 is distributed about the chassis to enable the system to generate a 360-degree representation of the surrounding area.

FIG. 1B shows an embodiment of the system 100 where the chassis 120 includes a drive system 104, a height-adjustable suspension system 112, and a mounting harness 122. In some embodiments, the drive system 104 is used to move the sanding device 110 along the path 103 during sanding operations. In further embodiments, the drive system 104 may include at least one motor 106 and a plurality of wheels 108. Each of the plurality of wheels 108 may be operatively coupled to a corresponding motor 106 such that the motor 106 drives the plurality of wheels 108 in a desired direction (e.g., along path 103). In some embodiments, each of the plurality of wheels is an omnidirectional wheel. In additional embodiments, the plurality of wheels may be replaced with an equivalent mobility system (e.g., tank tread, robot arm, computer numerical control (CNC) machine). The height-adjustable suspension system 112 may be a reconfigurable frame that enables the sanding device 110 to be moved closer to or retracted away from the surface 105. In some embodiments, each of the plurality of motors 106 is operatively coupled between the corresponding wheel 108 and height adjustable suspension system via a linear actuator and a rotary actuator so that the motor 106 may be used to raise the height-adjustable suspension system 112 and drive the corresponding wheel 108. The mounting harness 122 may be a dampening coupler that is connected between a main body 114 of the sanding device 110 and height-adjustable suspension system 112 of the chassis 120. In some embodiments, the mounting harness 122 prevents vibrations or jarring forces generated by the sanding device 110 from forcing the system 100 off the path 103 during the sanding operation. For example, a rubber collar may be positioned between the mounting harness 122 and the main body 114.

FIG. 1C shows an embodiment of the system 100 where the sanding device 110 is detachably coupled to the chassis 120. The mounting harness 122 may be an adjustable collar that enables the system 100 to be coupled to a plurality of different types of sanding devices (e.g., third-party sanding devices). In these embodiments, the chassis 120 includes the components for assessing the surface and the surrounding area, maneuvering around the workpiece, and engaging the surface 105 with various sanding elements 116. In some embodiments, a battery 130 (FIG. 1E) and a power port 132 (FIG. 1E) are further included in the chassis 120. The power port 132 may be an outlet that enables external sources to charge the battery 130 in the chassis 120. In some embodiments the sanding device 110 may be plugged into the power port 132 to enable the sanding device 110 to be powered by the battery 130 during the sanding operation.

FIG. 1D shows a top view of an embodiment where the system 100 further comprises a dust collection system 134 and a human machine interface (HMI) 124 (e.g., a touch screen, a keypad, a control panel). In some embodiments, dust collection system 134 is integrated into the chassis 120 such that debris and sawdust that is generated during the sanding operation is removed from the surface 105 to ensure a smooth and uniform finish is achievable. In some embodiments, the dust collection system 134 may be detachably coupled to a dust collection port on the sanding device 110 such that the dust collection system 134 is able to transport sawdust through available dust collection apertures on the sanding device 110, away from the surface 105, and into a dust collection receptacle for storage or disposal. In further embodiments, the HMI 124 may be mounted onto a sealed component housing 136 (FIG. 1A). The component housing 136 may be a watertight enclosure used to isolate the electronic components (e.g., a processor 118 (FIG. 1E) of the system 100 from dust and water in the external environment. For example, the sealed component enclosure 136 may enable the system 100 to perform wet sanding operations without moisture damaging the processor 118.

FIG. 1E shows a block diagram of communicable couplings between the components of the system (e.g., 102, 104, 110, 112, 124, 130, 132, 134) and the processor, 118. These coupling enable the processor to transmit or receive power or data to the components. In some embodiments, a wireless radio may be included in the processor to enable the system 100 to be remotely controlled.

### Example Flowchart(s)

The example flowchart(s) described herein convey example processing operations of methods that enable the various features and functionality of the system as described in detail above. The processing operations of each method presented below are intended to be illustrative and non-limiting. In some embodiments, for example, the methods may be accomplished with one or more additional operations not described, or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a field programmable gate array (FPGA), a digital circuit designed to process information, an analog circuit designed to process information, a state machine, or other mechanisms for electronically processing information). The processing devices may include one or more devices executing some or all of the operations of the methods in response to instructions stored electronically on an electronic storage medium. The processing devices may include one or more devices configured through hardware, firmware, or software to be specifically designed for execution of one or more of the operations of the methods.

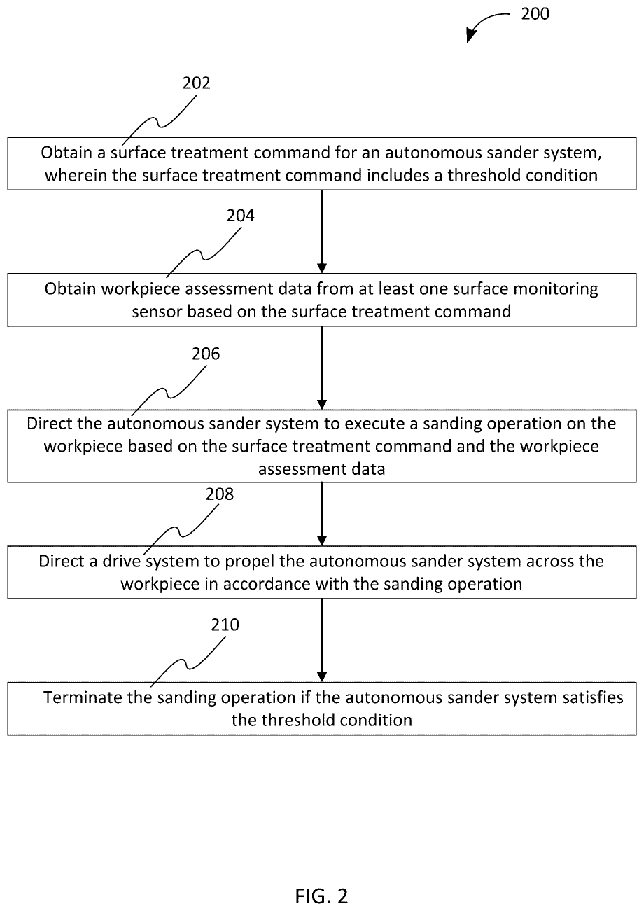

FIG. 2 illustrates a block diagram for a method 200 of implementing system 100. Method 200 may include obtaining, via the processor 118 (FIG. 1E), a surface treatment command for the autonomous sander system 100, wherein the surface treatment command includes a threshold condition (Block 202). The surface treatment command may be an input from a user that directs the system 100 to perform a specific sanding operation. The threshold condition acts as a limiting instruction that the user sets for the sanding operation. For example, the threshold condition may be a time period over which to perform the sanding operation. Thus, when the user issues the surface treatment command, they may specify the duration that the system 100 should spend sanding the surface 105 of the workpiece 101. The system 100 may then determine the optimal path 103 for evenly sanding the surface 105 within the allotted time period. Method 200 may further include obtaining, via the processor 118, workpiece assessment data from the at least one area-monitoring sensor 102 based on the surface treatment command (Block 204). In some embodiments, the workpiece assessment data may refer to data generated by the at least one area-monitoring sensor 102 that is used by the processor 118 to assess the features of the workpiece 101 and the surrounding area. For example, the surface 105 may be prepared for sanding by the application of sanding indicia (e.g., pencil marks, specific sanding instructions, path guidelines) that the at least one area-monitoring sensor 102 monitors throughout the sanding operation using optical sensors (e.g., one-dimensional (single beam) or 2D-(sweeping) laser rangefinders, 3D high definition light detection and ranging (lidar), 3D flash lidar, 2D or 3D sonar sensors, and one or more 2D cameras.). The sanding indicia may become less pronounced as the sanding operation progresses. In some embodiments the threshold condition is a sanding indicia score that refers to the percentage of the surface still covered in sanding indicia. In some embodiments, the processor 118 terminates the sanding operation when the workpiece assessment data includes data showing a sanding indicia score that indicates the workpiece 101 is free of sanding indicia.

Method 200 may include directing, via the processor 118, the autonomous sander system 100 to execute a sanding operation on the workpiece 101 based on the surface treatment command and the workpiece assessment data (Block 206). The method 200 may further include directing, via the processor, a drive system to propel the autonomous sander system across the workpiece in accordance with the sanding operation (Block 208). For example, the processor 118 may execute a random path planning routine to initialize the sanding operation and then generate an optimal path once sufficient workpiece assessment data has been gathered by the at least one area monitor sensor 102. Method 200 may further include terminating, via the processor 118, the sanding operation if the autonomous sander system 100 satisfies the threshold condition or the processor 118 determines the threshold condition is satisfied during the sanding operation (Block 210). For example, the system 100 may continue sanding along the optimal path 103 until the surface 105 achieves a desired smoothness or finish.

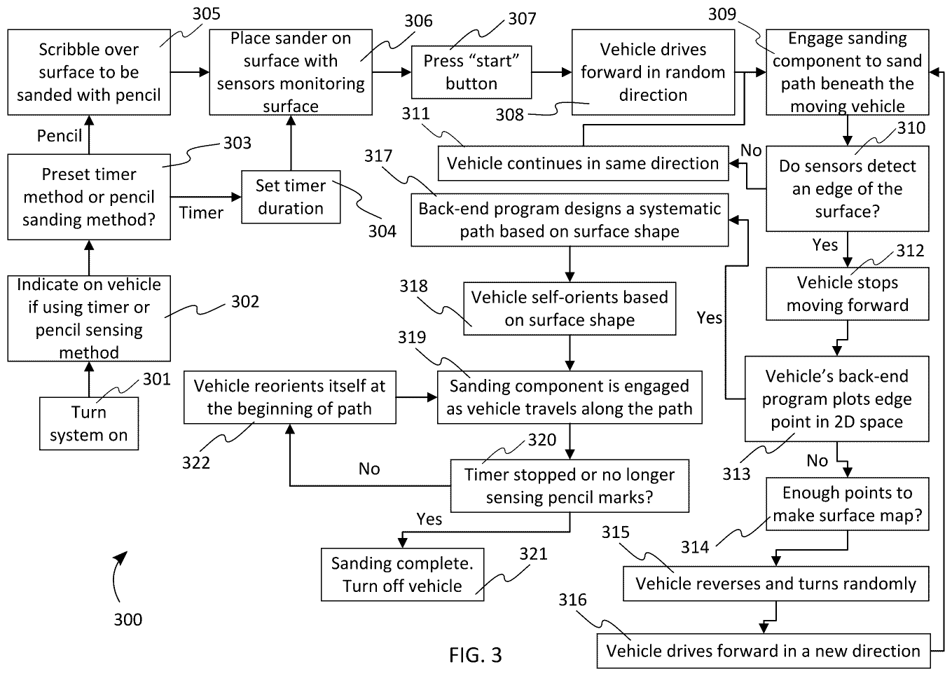

FIG. 3 illustrates a block diagram for performing a sanding operation 300. Operation 300 may include turning on the system and prompting a user to set the threshold condition as either a desired time period or a sanding indicia score (Blocks 301, 302, and 303). Operation 300 may include either setting a timer duration for the sanding operation or scribing sanding indicia onto the surface 105 (Blocks 304 and 305). Operation 300 may continue by positioning the system 100 onto the surface 105, receiving a start operation command (e.g., through the HMI 124), driving the chassis 120 in a first random direction, and engaging the sanding component 116 to sand the surface 105 as the system 100 travels along path 103 (Blocks 306, 307, 308, and 309). Operation 300, may further include continually assessing if there is an obstacle or edge and cither stopping the drive system 104 or continuing along the path 103 if no obstacles or edges are detected (Blocks 309, 310, 311, and 312). For example, operation 300 may include directing, via the processor 118, the drive system 104 to stop the autonomous sander system 100 if the workpiece assessment data indicates an edge or obstacle is within a threshold distance of the autonomous sander system 100 in the first direction. Operation 300 may further include generating an area map (e.g., a topological map of the surface 105, point clouds) of the workpiece 101 from the workpiece assessment data output by the at least one area monitor sensor 102 and assessing if the area map is sufficiently detailed (e.g., 90% or greater mapping of the workpiece) to generate the optimal path 103 (e.g., integrating, via the processor 118, the workpiece assessment data into an area map of the workpiece 101). System 100 may employ mapping and localization techniques (e.g., Simultaneous localization and mapping (SLAM), visual SLAM, acoustic visual SLAM, maximum a posteriori estimation (MAP), landmark-based mapping, raw-data based mapping, multi-lateration, real-time locating system) designed to enable the system 100 to autonomously navigate through unknown environments. Further, the system 100 may employ a machine learning model to improve mapping and pathing through successive completions of the optimal path. If the area map is not sufficiently detailed, then the .chassis 120 may be maneuvered and positioned to move forward along a second random direction. Operation 300 may then return to Block 309 to continue assessing the surface 105 and building the area map (Blocks 313, 314, 315, and 316).

In some embodiments, operation 300 may execute a path refinement operation based on the fidelity or completeness of the area map. The refinement operation may be used to improve the path 103 followed by the system 100. Further, the refinement process may include generating, via the processor 118, an optimal path 103 for the autonomous sander system 100 to travel during the sanding operation. Operation 300 may further include maneuvering the chassis 120 to the start of the optimal path 103 and engaging the sanding element 116 to sand the surface 105 (Blocks 317, 318, and 319). Operation 300 may further include repeating the optimal path 103 until the threshold condition has been satisfied (e.g., the surface 105 has achieved a desired finish) (Blocks 320, 321, and 322).

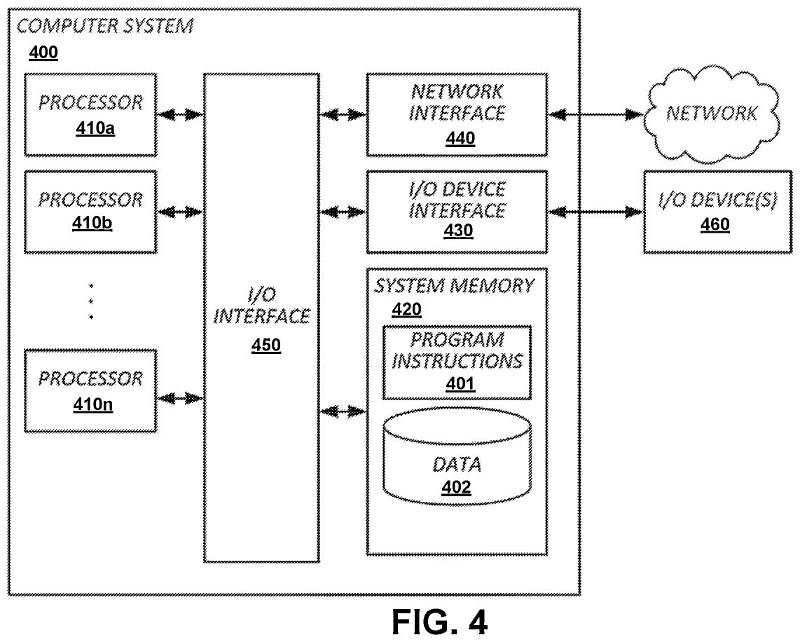

FIG. 4 is a diagram that illustrates an exemplary computing system 400 in accordance with embodiments of the present technique. Various portions of systems and methods described herein, may include or be executed on one or more computer systems similar to computing system 400. For example, the autonomous sanding system 100 may include the computing system 400. Further, processes and modules described herein may be executed by one or more processing systems similar to that of computing system 400.

Computing system 400 may include one or more processors (e.g., processors 410a-410n) coupled to system memory 420, an input/output I/O device interface 430, and a network interface 440 via an input/output (I/O) interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computing system 400 may be a uni-processor system including one processor (e.g., processor 410a), or a multi-processor system including any number of suitable processors (e.g., 410a-410n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 400 may include a plurality of computing devices (e.g., distributed computer systems) to implement various processing functions.

I/O device interface 430 may provide an interface for connection of one or more I/O devices 460 to computer system 400. I/O devices may include devices that receive input (e.g., from a user) or output information (e.g., to a user). I/O devices 460 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 460 may be connected to computer system 400 through a wired or wireless connection. I/O devices 460 may be connected to computer system 400 from a remote location. I/O devices 460 located on remote computer system, for example, may be connected to computer system 400 via a network and network interface 440.

Network interface 440 may include a network adapter that provides for connection of computer system 400 to a network. Network interface 440 may facilitate data exchange between computer system 400 and other devices connected to the network. Network interface 440 may support wired or wireless communication. The network may include an electronic communication network, such as the Internet, a local area network (LAN), a wide area network (WAN), a cellular communications network, or the like.

System memory 420 may be configured to store program instructions 401 or data 402. Program instructions 401 may be executable by a processor (e.g., one or more of processors 410a-410n) to implement one or more embodiments of the present techniques. Instructions 401 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 420 may include a non-transitory computer readable storage medium that may have program instructions stored thereon that are executable by a computer processor (e.g., one or more of processors 410a-410n) to cause the subject matter and the functional operations described herein. A memory (e.g., system memory 420) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 450 may be configured to coordinate I/O traffic between processors 410a-410n, system memory 420, network interface 440, I/O devices 460, and/or other peripheral devices. I/O interface 450 may perform protocol, timing, or other data transformations to convert data signals from one component (e.g., system memory 420) into a format suitable for use by another component (e.g., processors 410a-410n). I/O interface 450 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 400 or multiple computer systems 400 configured to host different portions or instances of embodiments. Multiple computer systems 400 may provide for parallel or sequential processing/execution of one or more portions of the techniques described herein.

Those skilled in the art will appreciate that computer system 400 is merely illustrative and is not intended to limit the scope of the techniques described herein. Computer system 400 may include any combination of devices or software that may perform or otherwise provide for the performance of the techniques described herein. For example, computer system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provide by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The following list of embodiments describes various aspects of the systems and methods described herein, which may be combined in any combination.
1: A non-transitory, machine-readable medium storing instructions that, when executed by at least one processor, effectuate operations that may include: obtaining, via the processor, a surface treatment command for an autonomous sander system, where the surface treatment command includes a threshold condition; obtaining, via the processor, workpiece assessment data from at least one area-monitoring sensor based on the surface treatment command; directing, via the processor, the autonomous sander system to execute a sanding operation on the workpiece based on the surface treatment command and the workpiece assessment data; directing, via the processor, a drive system to propel the autonomous sander system across the workpiece in accordance with the sanding operation; and terminating, via the processor, the sanding operation if the autonomous sander system satisfies the threshold condition.
2: The medium as Embodiment 1 describes, where the threshold condition is a time period, and where the processor terminates the sanding operation when the time period expires.
3: The medium as either of Embodiment 1 or 2 describe, where the threshold condition is a sanding indicia score, and where the processor terminates the sanding operation when the workpiece assessment data includes the sanding indicia score that indicates the workpiece is free of sanding indicia.
4: The medium as any of Embodiments 1-3 describe, where the sanding operation may include: directing, via the processor, the drive system to propel the autonomous sander system in a first direction; directing, via the processor, a sanding component of the autonomous sanding system to sand a surface of the workpiece; directing, via the processor, the drive system to stop the autonomous sander system if the workpiece assessment data indicates an edge or obstacle is within a threshold distance of the autonomous sander system in the first direction; integrating, via the processor, the workpiece assessment data into an area map of the workpiece; determining, via the processor, if the area map is sufficiently detailed to model the workpiece surface; and executing, via the processor, a path refinement operation based on the determining.
5: The medium as any of Embodiments 1˜4 describe, where the path refinement operation includes directing, via the processor, the drive system to maneuver the autonomous sander system to be propelled along a second direction if the area map is not sufficiently detailed.
6: The medium as any of Embodiments 1-5 describe, where the path refinement operation further may include: generating, via the processor, an optimal path for the autonomous sander system to travel during the sanding operation; and directing, via the processor, the drive system to maneuver the autonomous sander system to be propelled along the optimal path during the sanding operation.
7: The medium as any of Embodiments 1-6 describe, where the sanding operation further may include restarting the optimal path if the threshold condition is not satisfied.
8: The medium as any of Embodiments 1-7 describe, where the autonomous sanding system further may include a sanding device detachably coupled to a chassis.
9: An autonomous sander system may include: a chassis; a drive system operatively coupled to the chassis, where the drive system is configured to propel the autonomous sander system across a workpiece; at least one processor coupled to the autonomous sander system and at least one area-monitoring sensor; and system memory coupled to the at least one processor and that includes at least one instruction that, when executed by the at least one processor, effectuate operations may include: obtaining a surface treatment command for an autonomous sander system, where the surface treatment command includes a threshold condition; obtaining workpiece assessment data from the at least one area-monitoring sensor based on the surface treatment command; directing the autonomous sander system to execute a sanding operation on the workpiece based on the surface treatment command and the workpiece assessment data; directing the drive system to propel the autonomous sander system across the workpiece in accordance with the sanding operation; and terminating the sanding operation if the autonomous sander system satisfies the threshold condition.
10: The system as Embodiment 9 describes, where the threshold condition is a time period, and where the processor terminates the sanding operation when the time period expires.
11: The system as either of Embodiment 9 or 10 describe, where the threshold condition is a sanding indicia score, and where the processor terminates the sanding operation when the workpiece assessment data includes the sanding indicia score that indicates the workpiece is free of sanding indicia.
12: The system as any of Embodiments 9-11 describe, where the sanding operation may include: directing, via the processor, the drive system to propel the autonomous sander system in a first direction; directing, via the processor, a sanding component of the autonomous sanding system to sand a surface of the workpiece; directing, via the processor, the drive system to stop the autonomous sander system if the workpiece assessment data indicates an edge or obstacle is within a threshold distance of the autonomous sander system in the first direction; integrating, via the processor, the workpiece assessment data into an area map of the workpiece; determining, via the processor, if the area map is sufficiently detailed to model the workpiece surface; and executing, via the processor, a path refinement operation based on the determining.
13: The system as any of Embodiments 9-12 describe, where the path refinement operation includes directing, via the processor, the drive system to maneuver the autonomous sander system to be propelled along a second direction if the area map is not sufficiently detailed.
14: The system as any of Embodiments 9-13 describe, where the path refinement operation further may include: generating, via the processor, an optimal path for the autonomous sander system to travel during the sanding operation; and directing, via the processor, the drive system to maneuver the autonomous sander system to be propelled along the optimal path during the sanding operation.
15: The system as any of Embodiments 9-14 describe, where the sanding operation further may include restarting the optimal path if the threshold condition is not satisfied.
16: The system as any of Embodiments 9-15 describe, where the autonomous sanding system further may include a sanding device detachably coupled to a chassis.
17: A method may include: obtaining, via at least one processor, a surface treatment command for an autonomous sander system, where the surface treatment command includes a threshold condition; obtaining, via the processor, workpiece assessment data from at least one area-monitoring sensor based on the surface treatment command; directing, via the processor, the autonomous sander system to execute a sanding operation on the workpiece based on the surface treatment command and the workpiece assessment data; directing, via the processor, a drive system to propel the autonomous sander system across the workpiece in accordance with the sanding operation; terminating, via the processor, the sanding operation if the autonomous sander system satisfies the threshold condition; where the sanding operation may include; directing, via the processor, the drive system to propel the autonomous sander system in a first direction; directing, via the processor, a sanding component of the autonomous sanding system to sand a surface of the workpiece; directing, via the processor, the drive system to stop the autonomous sander system if the workpiece assessment data indicates an edge or obstacle is within a threshold distance of the autonomous sander system in the first direction; integrating, via the processor, the workpiece assessment data into an area map of the workpiece; determining, via the processor, if the area map is sufficiently detailed to model the workpiece surface; executing, via the processor, a path refinement operation based on the determining; where the path refinement operation includes directing, via the processor, the drive system to maneuver the autonomous sander system to be propelled along a second direction if the area map is not sufficiently detailed; where the path refinement operation further may include; generating, via the processor, an optimal path for the autonomous sander system to travel during the sanding operation; directing, via the processor, the drive system to maneuver the autonomous sander system to be propelled along the optimal path during the sanding operation; and directing, via the processor, the autonomous sander system to restart the optimal path if the threshold condition is not satisfied.
18: The method as Embodiment 17 describes, where the threshold condition is a time period, and where the processor terminates the sanding operation when the time period expires.
19: The method as either of Embodiment 17 or 18 describe, where the threshold condition is a sanding indicia score, and where the processor terminates the sanding operation when the workpiece assessment data includes the sanding indicia score that indicates the workpiece is free of sanding indicia.
20: The method as any of Embodiments 17-19 describe, where the autonomous sanding system further may include a sanding device detachably coupled to a chassis.

What is claimed is:

1. A non-transitory, machine-readable medium storing instructions that, when executed by at least one processor, effectuate operations comprising:
obtaining, via the at least one processor, a surface treatment command for an autonomous sander system, wherein the surface treatment command includes a threshold condition;
obtaining, via the at least one processor, workpiece assessment data associated with a workpiece from at least one area-monitoring sensor based on the surface treatment command;
directing, via the at least one processor, the autonomous sander system to execute a sanding operation on the workpiece based on the surface treatment command and the workpiece assessment data;
directing, via the at least one processor, a drive system to propel the autonomous sander system across the workpiece in accordance with the sanding operation; and
terminating, via the at least one processor, the sanding operation if the autonomous sander system satisfies the threshold condition.

2. The medium of claim 1, wherein the threshold condition is a time period, and wherein the at least one processor terminates the sanding operation when the time period expires.

3. The medium of claim 1, wherein the threshold condition is a sanding indicia score, and wherein the at least one processor terminates the sanding operation when the workpiece assessment data includes the sanding indicia score that indicates the workpiece is free of sanding indicia.

4. The medium of claim 1, wherein the sanding operation comprises:
directing, via the at least one processor, the drive system to propel the autonomous sander system in a first direction;
directing, via the at least one processor, a sanding component of the autonomous sander system to sand a surface of the workpiece;
directing, via the at least one processor, the drive system to stop the autonomous sander system if the workpiece assessment data indicates an edge or obstacle is within a threshold distance of the autonomous sander system in the first direction;
integrating, via the at least one processor, the workpiece assessment data into an area map of the workpiece;
determining, via the at least one processor, if the area map is sufficiently detailed to model a workpiece surface of the workpiece; and
executing, via the at least one processor, a path refinement operation based on the determining.

5. The medium of claim 4, wherein the path refinement operation includes directing, via the at least one processor, the drive system to maneuver the autonomous sander system to be propelled along a second direction if the area map is not sufficiently detailed.

6. The medium of claim 4, wherein the path refinement operation further comprises:
generating, via the at least one processor, an optimal path for the autonomous sander system to travel during the sanding operation; and
directing, via the at least one processor, the drive system to maneuver the autonomous sander system to be propelled along the optimal path during the sanding operation.

7. The medium of claim 6, wherein the sanding operation further comprises restarting the optimal path if the threshold condition is not satisfied.

8. The medium of claim 1, wherein the autonomous sander system further comprises a sanding device detachably coupled to a chassis.

9. An autonomous sander system comprising:
a chassis;
a drive system operatively coupled to the chassis, wherein the drive system is configured to propel the autonomous sander system across a workpiece;
at least one processor coupled to the autonomous sander system and at least one area-monitoring sensor; and
system memory coupled to the at least one processor and that includes at least one instruction that, when executed by the at least one processor, effectuate operations comprising:
obtaining a surface treatment command for the autonomous sander system, wherein the surface treatment command includes a threshold condition;
obtaining workpiece assessment data from the at least one area-monitoring sensor based on the surface treatment command;
directing the autonomous sander system to execute a sanding operation on the workpiece based on the surface treatment command and the workpiece assessment data;
directing the drive system to propel the autonomous sander system across the workpiece in accordance with the sanding operation; and
terminating the sanding operation if the autonomous sander system satisfies the threshold condition.

10. The autonomous sander system of claim 9, wherein the threshold condition is a time period, and wherein the at least one processor terminates the sanding operation when the time period expires.

11. The autonomous sander system of claim 9, wherein the threshold condition is a sanding indicia score, and wherein the at least one processor terminates the sanding operation when the workpiece assessment data includes the sanding indicia score that indicates the workpiece is free of sanding indicia.

12. The autonomous sander system of claim 9, wherein the sanding operation comprises:
directing, via the at least one processor, the drive system to propel the autonomous sander system in a first direction;
directing, via the at least one processor, a sanding component of the autonomous sander system to sand a surface of the workpiece;
directing, via the at least one processor, the drive system to stop the autonomous sander system if the workpiece assessment data indicates an edge or obstacle is within a threshold distance of the autonomous sander system in the first direction;
integrating, via the at least one processor, the workpiece assessment data into an area map of the workpiece;
determining, via the at least one processor, if the area map is sufficiently detailed to model a workpiece surface of the workpiece; and
executing, via the at least one processor, a path refinement operation based on the determining.

13. The autonomous sander system of claim 12, wherein the path refinement operation includes directing, via the at least one processor, the drive system to maneuver the autonomous sander system to be propelled along a second direction if the area map is not sufficiently detailed.

14. The autonomous sander system of claim 12, wherein the path refinement operation further comprises:
generating, via the at least one processor, an optimal path for the autonomous sander system to travel during the sanding operation; and
directing, via the at least one processor, the drive system to maneuver the autonomous sander system to be propelled along the optimal path during the sanding operation.

15. The autonomous sander system of claim 14, wherein the sanding operation further comprises restarting the optimal path if the threshold condition is not satisfied.

16. The autonomous sander system of claim 9, further comprising: a sanding device detachably coupled to the chassis.

17. A method comprising:
obtaining, via at least one processor, a surface treatment command for an autonomous sander system, wherein the surface treatment command includes a threshold condition;
obtaining, via the at least one processor, workpiece assessment data of a workpiece from at least one area-monitoring sensor based on the surface treatment command;
directing, via the at least one processor, the autonomous sander system to execute a sanding operation on the workpiece based on the surface treatment command and the workpiece assessment data;
directing, via the at least one processor, a drive system to propel the autonomous sander system across the workpiece in accordance with the sanding operation;
terminating, via the at least one processor, the sanding operation if the autonomous sander system satisfies the threshold condition;
wherein the sanding operation comprises;
directing, via the at least one processor, the drive system to propel the autonomous sander system in a first direction;
directing, via the at least one processor, a sanding component of the autonomous sander system to sand a surface of the workpiece;
directing, via the at least one processor, the drive system to stop the autonomous sander system if the workpiece assessment data indicates an edge or obstacle is within a threshold distance of the autonomous sander system in the first direction;
integrating, via the at least one processor, the workpiece assessment data into an area map of the workpiece;
determining, via the at least one processor, if the area map is sufficiently detailed to model a workpiece surface of the workpiece;
executing, via the at least one processor, a path refinement operation based on the determining, wherein the path refinement operation includes:
directing, via the at least one processor, the drive system to maneuver the autonomous sander system to be propelled along a second direction if the area map is not sufficiently detailed, and
generating, via the at least one processor, an optimal path for the autonomous sander system to travel during the sanding operation;
directing, via the at least one processor, the drive system to maneuver the autonomous sander system to be propelled along the optimal path during the sanding operation; and
directing, via the at least one processor, the autonomous sander system to restart the optimal path if the threshold condition is not satisfied.

18. The method of claim 17, wherein the threshold condition is a time period, and wherein the at least one processor terminates the sanding operation when the time period expires.

19. The method of claim 17, wherein the threshold condition is a sanding indicia score, and wherein the at least one processor terminates the sanding operation when the workpiece assessment data includes the sanding indicia score that indicates the workpiece is free of sanding indicia.

20. The method of claim 17, wherein the autonomous sander system further comprises a sanding device detachably coupled to a chassis.
